(19) United States
(12) Patent Application Publication
(10) Pub. No.: US 2020/0188956 A1
(43) Pub. Date: Jun. 18, 2020

(54) VIBRATION SOURCE

(71) Applicant: Quantum Control Works, L.C., Des Moines, IA (US)

(72) Inventor: CHARLES B. BRIGHT, AMES, IA (US)

(21) Appl. No.: 16/715,988

(22) Filed: Dec. 16, 2019

Related U.S. Application Data
(60) Provisional application No. 62/780,717, filed on Dec. 17, 2018.

(51) Int. Cl. B06B 1/08; B06B 1/02

(52) U.S. Cl. CPC B06B 1/08; B06B 1/0215

(57) ABSTRACT

An actuator comprises a magnetostrictive element operably connected to a solenoid coil, preloaded to a default length, having an expanded length greater than the default length, and having a compressed length less than the default length. The compressed length of the magnetostrictive element is not less than a length at which permanent mechanical degradation of the magnetostrictive element occurs. An output element is disposed proximate to a terminal end of the actuator and movable between an original position and an actuated position. The coil can be energized or deenergized between a lower level and a higher level for part or all of an expansion or compression of the magnetostrictive element anywhere within the range between the compressed length and the expanded length. The magnetostrictive element can comprise a terbium alloy.

### CROSS REFERENCE TO RELATED APPLICATIONS

This application claims priority under 35 U.S.C. § 119 to provisional patent application U.S. Ser. No. 62/780,717, filed Dec. 17, 2018. The provisional patent application is herein incorporated by reference in its entirety, including without limitation, the specification, claims, and abstract, as well as any figures, tables, appendices, or drawings thereof.

This application also relates to at least some of the subject matter disclosed in U.S. Pre-Grant Publication No. 2016/0377040 and U.S. Pat. Nos. 7,255,290; 8,113,179; 8,418,676; 8,683,982; and 9,385,300, all of which are also to Charles B. Bright. The pre-grant publication and these patents are herein incorporated by reference in their entirety, including without limitation, the specification, claims, and abstract, as well as any figures, tables, appendices, or drawings thereof.

### FIELD OF THE INVENTION

The present disclosure relates generally to devices that convert electrical input to mechanical output. More particularly, but not exclusively, the present disclosure relates to an improved device, system and/or method for a durable, continuously controllable, fast, compact, and powerful source of vibration. Continuous controllability enables the device to be energized to vibrate as desired without generating undesired harmonics.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

For reasons disclosed in at least U.S. Pat. Nos. 7,255,290; 8,113,179; 8,418,676; 8,683,982; and 9,385,300; an alloy offers a unique combination of inherent properties that enable a durable electromechanical actuator with high mechanical power density. Terbium (element number 65 on the periodic chart of the elements) inseparably couples magnetic with mechanical effects. This unusual phenomenon, called magnetostriction, is indestructible; it cannot be permanently degraded because it originates from quantum mechanics within the terbium atom itself. Terbium is combined with dysprosium (element number 66) and iron to package this effect into a useful actuator alloy. This terbium alloy is among the best known couplers of magnetic input to mechanical output.

In general, magnetostrictive materials convert a magnetic input to a mechanical output and vice versa. With respect to a terbium alloy actuator that converts magnetic input to mechanical output, a solenoid coil surrounds the magnetostrictive element. Electrical input energizes the solenoid coil to create a magnetic field. The terbium alloy magnetostrictive element converts that magnetic input to a mechanical output. The mechanical expansion of the terbium alloy is a nearly linear scale of the strength of the applied magnetic field. Reduction in field strength reduces expansion. In addition, the time rate at which the terbium alloy expands or contracts is a nearly linear scale of the time rate of change of that applied magnetic field. Thus, this alloy features continuous control over mechanical output. Within the operating range of a single actuator, it enables both fast and small mechanical outputs as well as slow and large mechanical outputs and anything in between as desired and as continuously controlled by continuously controlling its electrical input.

Besides continuous control, the quantum mechanical origin of its magnetostrictive effect endows the terbium alloy with the inherent durability to survive demanding environments. Magnetostriction has not been observed to fatigue the terbium alloy and high temperatures do not permanently degrade it. Since the energizing solenoid coil surrounds the terbium alloy magnetostrictive element of an actuator but does not contact it, the magnetic field is applied without direct contact, avoiding fatigue of any component.

As would be expected, this desirable behavior cannot be without limit. There are at least four operational limits and two destructive limits to observe.

The first operational limit is that the terbium alloy expands regardless of the polarity of the incident magnetic field. Magnetic bias obtains unbiased mechanical output for unbiased electrical input. That is, the magnetic bias partially expands the terbium alloy. Obeying the principle of superposition, an incident magnetic field supplied by the energized solenoid coil will add to or subtract from the bias field already within the magnetostrictive element.

The second operational limit is that despite further increases in field, the alloy will not expand past a point. This characteristic is referred to as saturation.

The third operational limit is that since the terbium alloy itself is an electrical conductor, eddy currents are induced by an incident time-varying magnetic field. Although magnetostriction is an atomic phenomenon that is fast at that level, eddy currents temporarily shield part of the alloy from the field, which delays mechanical response. Known countermeasures enable effective ultrasonic actuators.

The fourth operational limit, if it goes high enough, is also the first destructive limit. “High temperature” as meant in this disclosure is below the alloy's melting temperature and preferably below its Curie temperature. Melting is destructive. Mechanical response of the terbium alloy below its Curie temperature is generally linearly related to temperature. Thus, performance decreases as temperature rises until it is zero at the Curie temperature. Conversely, if it has not been melted, performance rises as temperature drops below the Curie temperature until it is below a certain point.

The second destructive limit is the mechanical strength of the terbium alloy. No matter how it is operated, the mechanical limit of the actuator is simply the mechanical strength of the terbium alloy. When operated inside this one limit, performance has not been observed to degrade over time. The limit can be exceeded at either the maximum or the minimum displacement amplitude of the actuator. As meant here, “maximum displacement amplitude” refers to the maximum length of the terbium alloy magnetostrictive element under dynamic circumstances and “minimum displacement amplitude” refers to the minimum length of the terbium alloy magnetostrictive element under dynamic or static circumstances. The terbium alloy assembled into an actuator but not electrically energized is at its default length.

The mechanical strength limit can be exceeded at maximum displacement amplitude by shock impact reloading. Acceleration amplitudes have been known to be high enough such that the force used to keep the actuator load in contact with the actuator may be exceeded. That is, a gap may open between the expanded actuator and the load which continues traveling ballistically at that point. Re-establishing contact by impact between the load and the actuator may shock and thus fracture the terbium alloy. A design feature proven to render impact fracture less likely is to bond another material to each end of the terbium alloy magnetostrictive element, the design feature here referred to as an end cap. The two key features of the end caps are to be made of any suitable material that is stronger than the terbium alloy and be made into any form that will fit into the design. This feature is disclosed in U.S. Pat. No. 9,385,300.

A need exists in the art for a simple actuator that offers linear, durable, fast, and powerful broadband output of continuously variable force and/or displacement.

### SUMMARY OF THE INVENTION

Within its destructive limits, terbium alloy performance has never been observed to be degraded by any known combination of high stress, high strain, high field, and/or high temperature. Because at least high stress and high strain are required, it is theorized that the upper limit of mechanical power density for the terbium alloy occurs very close to its mechanical strength limit. In other words, this mechanical power density limit coincides with maximum compressive stress and/or minimum displacement amplitude.

The elastic modulus of the terbium alloy is relatively soft. This can be of great advantage for both power density and flexible operation, key features of a durable actuator intended to provide powerful and precisely controllable vibration. The soft elastic modulus permits superposition to be used to obtain larger displacement magnitudes from smaller electrical inputs. The durable nature of the terbium alloy permits long life to be expected with larger displacement magnitudes.

Because the terbium alloy only expands with magnetic field, maximizing vibration amplitude using superposition occurs when the solenoid is energized to further expand the alloy as it is already expanding due to harmonic resonance. The magnetic field can be lower but is preferably absent during that portion of the vibrational cycle when the terbium alloy is being compressed by its harmonic load. In contrast, reversing the times at which the solenoid is energized or de-energized with respect to the motion will act as a brake.

If enough magnetic field is available, harmonic resonance need not be used to achieve high vibration amplitude.

It is thus a primary object, feature, and/or advantage of the present invention to improve on or overcome the deficiencies in the art.

It is still yet a further object, feature, and/or advantage of the present invention to provide an actuator that can precisely control its mechanical load throughout the entire range of conditions to which the load is subject.

It is still yet a further object, feature, and/or advantage of the present invention to variably control the electrical input to the magnetostrictive actuator such that its mechanical load moves slowly or quickly in either direction.

It is still yet a further object, feature, and/or advantage of the present invention to preload the magnetostrictive element to prevent shock impact reloading during operation.

It is still yet a further object, feature, and/or advantage of the present invention to provide a safe, cost effective, fast, powerful, variable, and durable magnetostrictive actuator.

It is still yet a further object, feature, and/or advantage of the present invention to protect the magnetostrictive element from fracturing in the event of a shock impact reload during operation.

It is still yet a further object, feature, and/or advantage of the present invention to define one limit of operation as the compressive strength limit of the terbium alloy.

It is still yet a further object, feature, and/or advantage of the present invention to apply electrical input that (1) starts with or without zero slope and/or ends with or without zero slope; and/or (2) starts at zero with or without zero slope and/or ends at zero with or without zero slope.

It is still yet a further object, feature, and/or advantage of the present invention to practice methods which facilitate use, manufacture, assembly, maintenance, and repair of a magnetostrictive actuator accomplishing some or all of the previously stated objectives.

It is still yet a further object, feature, and/or advantage of the present invention to incorporate the magnetostrictive actuator into a system accomplishing some or all of the previously stated objectives. For example, the system can include a control signal, a source of energy for the control signal, the actuator, and a mechanism configured to be mechanically moved when the actuator receives the control signal.

The previous objects, features, and/or advantages of the present invention, as well as the following aspects and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

According to some aspects of the present disclosure, an improved magnetostrictive actuator comprises a magnetostrictive element operably connected to a solenoid coil. In one embodiment, the magnetostrictive element is a terbium alloy. The magnetostrictive element has a compressed length, a default length, an expanded length, and any number of lengths between the compressed and expanded lengths. Each end of the magnetostrictive element preferably features an end cap made from a material that is stronger than the magnetostrictive element and is bonded on. Each end cap is shaped in accordance with the demands of the particular design, with flat ends being typical.

The length of the magnetostrictive element is selectively variable between the compressed length and expanded length to selectively position the mechanical load at any point within its operating range.

A biasing element or elements can be operably connected to the actuator and/or the mechanical load and configured to bias the magnetostrictive element to a default length position with the actuator at rest.

According to some other aspects of the present disclosure, a method for moving a load comprises providing electromagnetically connecting a magnetostrictive element of an actuator to a solenoid coil; mechanically positioning the load; and (a) energizing the solenoid coil to cause expansion of the magnetostrictive element or (b) deenergizing the solenoid coil to cause contraction of the magnetostrictive element. The load is displaced by the expansion or contraction of the magnetostrictive element. The method can further comprise, in part as a result of the expansion or the contraction of the magnetostrictive element, selectively, continuously, and variably controlling the position of the load.

According to some other aspects of the present disclosure, a method for moving a load comprises electromagnetically connecting a magnetostrictive element of an actuator to a solenoid coil; mechanically positioning the load; and energizing and deenergizing the solenoid coil in a periodic manner such that contraction causes the magnetostrictive element to be compressed further than a default length before the solenoid is energized or deenergized again. The expansion of the magnetostrictive element can be selectively controlled to variably vibrate the load.

These and/or other objects, features, advantages, aspects, and/or embodiments will become apparent to those skilled in the art after reviewing the following brief and detailed descriptions of the drawings.

### BRIEF DESCRIPTION OF THE DRAWINGS

FIG. 1 shows an external view of a magnetostrictive actuator, according to some aspects of the present disclosure.

FIG. 2 shows a cross-sectional view of the magnetostrictive actuator of FIG. 1, according to some aspects of the present disclosure.

FIG. 3 graphs displacement with respect to time for a periodic energization, according to some aspects of the present disclosure.

FIG. 4 graphs displacement with respect to time for non-periodic energization, according to some aspects of the present disclosure.

Several embodiments in which the present invention may be practiced are illustrated and described in detail, wherein like reference characters represent like components throughout the several views. The drawings are presented for exemplary purposes and may not be to scale, unless otherwise indicated, and thus proportions of features in the drawings shall not be construed as evidence of actual proportions.

### DETAILED DESCRIPTION OF THE INVENTION

### Definitions—Introductory Matters

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” as used herein are not intended to refer to any single embodiment of the particular invention but encompass all possible embodiments as described in the specification and the claims.

The term “about” as used herein refers to slight variations in numerical quantities with respect to any quantifiable variable. One of ordinary skill in the art will recognize inadvertent error can occur, for example, through use of typical measuring techniques or equipment or from differences in the manufacture, source, or purity of components. The claims include equivalents to the quantities whether or not modified by the term “about.”

The term “configured” describes an apparatus, system, or other structure that is constructed to perform or capable of performing a particular task or to adopt a particular configuration. The term “configured” can be used interchangeably with other similar phrases such as constructed, arranged, adapted, manufactured, and the like.

Terms characterizing a sequential order (e.g., first, second, etc.), a position (e.g., top, bottom, lateral, medial, forward, aft, etc.), and/or an orientation (e.g., width, length, depth, thickness, vertical, horizontal, etc.) are referenced according to the views presented. Unless context indicates otherwise, these terms are not limiting. The physical configuration of an object or combination of objects may change without departing from the scope of the present invention.

As would be apparent to one of ordinary skill in the art, mechanical, procedural, or other changes may be made without departing from the spirit and scope of the invention. The scope of the invention is defined only by the appended claims, along with the full scope of equivalents to which such claims are entitled.

### Overview

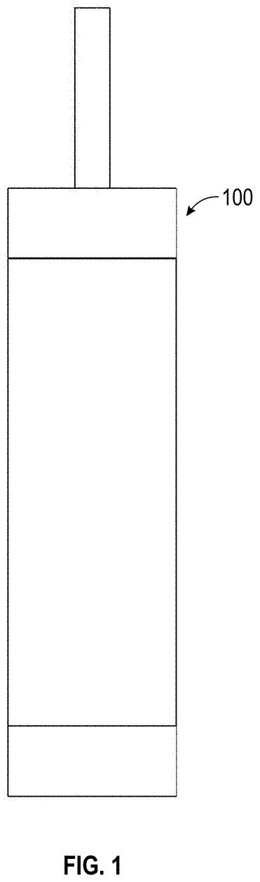

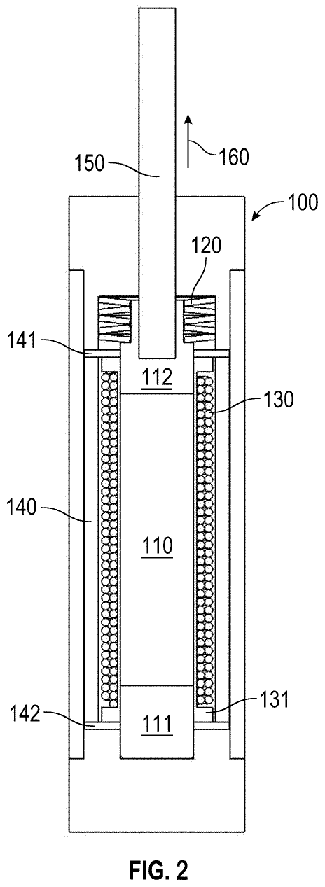

FIGS. 1 and 2 show an actuator 100 in accordance with an illustrative embodiment of the present disclosure.

Magnetostrictive element 110 can comprise an alloy including one or more rare earth and/or transition elements. More specifically, the alloy can be formed of grain-oriented polycrystalline rare earth and/or transition metal materials of the formula TbₓDyₓ₋₁Fe_{2-w}, wherein 0.20≤x≤1.00 and 0≤w≤0.20. The grains of the material have their common principal axes substantially along the growth axis of the material. As the alloy has its grain oriented in the axial direction, the favored direction of magnetostrictive response of magnetostrictive element 110 is formed into a shape with ends that are substantially parallel to each other and substantially perpendicular to the favored direction of magnetostrictive response. Magnetostrictive element 110 can have a transverse dimension perpendicular to the direction of magnetostrictive response substantially smaller than one-quarter wavelength at the electromechanical resonant frequency of the apparatus. Magnetostrictive element 110 can have a length in the direction of magnetostrictive response of no greater than one-quarter wavelength at the electromechanical resonant frequency of the apparatus. Magnetostrictive element 110 has a default length and is configured to expand to an expanded length and/or is selectively expandable to any length between the default length and the expanded length to selectively control its displacement output.

In an exemplary embodiment, magnetostrictive element 110 is elongated or rod-shaped. In a preferred embodiment, magnetostrictive element 110 is cylindrical, but the present disclosure contemplates the shape can be an ellipsoid, parallelepiped, prismatic, or other similar or suitable shapes. To guard against fracture of magnetostrictive element 110, a fixed end cap 111 can be secured to the immobile end or end cap 111 of magnetostrictive element 110 and a moving end cap 112 can be secured to the mobile end of magnetostrictive element 110. In a preferred embodiment, end caps 111 and 112 are made of a hardened material. End caps 111 and 112 distribute the load across each face of magnetostrictive element 110 through the compliant epoxy used for bonding.

Actuator 100 includes a preloading element 120. Preloading element 120 compresses magnetostrictive element 110 from its free length to its default length.

Actuator 100 includes a solenoid coil 130. Solenoid coil 130 can include one or more windings of conductive wire. In the exemplary embodiment illustrated in FIG. 2, solenoid coil 130 has two layers of windings. Solenoid coil 130 can be wound about a bobbin 131 comprised of non-conductive material. Thus, bobbin 131 is coaxially disposed between the solenoid coil 130 and the magnetostrictive element 110.

A magnetic flux return path is provided to guide the lines of magnetic force around the outside of the solenoid coil 130 from one end of magnetostrictive element 110 to the other. In addition to end caps 111 and 112, the magnetic flux return path consists of cylinder 140, disk 141, and disk 142, preferably fabricated of ferromagnetic material.

Some aspects of the technical operation of magnetostrictive element 110 are described in co-pending, co-owned U.S. patent application Ser. No. 14/174,560, filed on Feb. 6, 2014, and Ser. No. 14/577,240, filed on Dec. 14, 2014, both of which are incorporated herein by reference in their entireties. In short, a voltage waveform of one polarity is applied, inducing a current waveform of matching polarity to flow through solenoid coil 130. The current within solenoid coil 130 establishes a magnetic field of matching polarity. This magnetic field generates magnetic lines of force that cross into magnetostrictive element 110 with corresponding magnetic flux density of matching polarity. Lines of magnetic flux close back on themselves through flux return path 140, 141, and 142 which, together with magnetostrictive element 110, forms a complete magnetic circuit. The magnetic flux waveform within magnetostrictive element 110, regardless of polarity, causes a corresponding axial expansion. Continuous control of current into solenoid coil 130 continuously controls the axial expansion or contraction of magnetostrictive element 110. The rate at which current increases or decreases and its maximum magnitude are both converted by magnetostrictive element 110 into corresponding mechanical displacement. As used herein, “contract” or “contraction” refer to the shortening of magnetostrictive element 110 from a length greater than the default length.

To achieve the advantages of magnetostrictive actuation of a vibrator, the expansion and contraction of magnetostrictive element 110 must be translated into a corresponding output that provides for precise and variable control over vibration.

The biasing element 120 is operably connected to output element 150 and configured to bias the output element 150 to the default, unenergized position. The biasing element 120 can include a compression spring and/or shim. In the illustrated embodiment of FIG. 2, the biasing element 120 is disposed between the output element 150 and moving end cap 112.

In operation, as solenoid 130 is energized and magnetostrictive element 110 expands, end cap 112 moves output element 150 in the direction of arrow 160.

After completion of an expansion event, solenoid 130 is deenergized and magnetostrictive element 110 contracts from its the expanded length. Due to the contraction of magnetostrictive element 110, magnetostrictive element 110 no longer forces output element 150 to push on its load (not shown). Rather, the forces on the end of output element 150 from the load, together with biasing element 120, overcome the forces associated with the motion of the load. As a result, output element 150 returns from the expanded position to the de-energized position.

Output element 150, which remains adjacent to and/or in direct contact with end cap 120 of magnetostrictive element 110, further provides a constant compressive force on magnetostrictive element 110. This advantageous feature results in a compressive preload on magnetostrictive element 110 and prevents tensile failure during operation. Further, magnetostrictive element 110 has a default length and is configured to expand to an expanded length, and/or selectively expandable to any length between the default length and the expanded length to selectively control displacement. Selectively controlling the expansion or contraction of magnetostrictive element 110 variably controls the magnitude of displacement, thereby selectively controlling the magnitude of vibration.

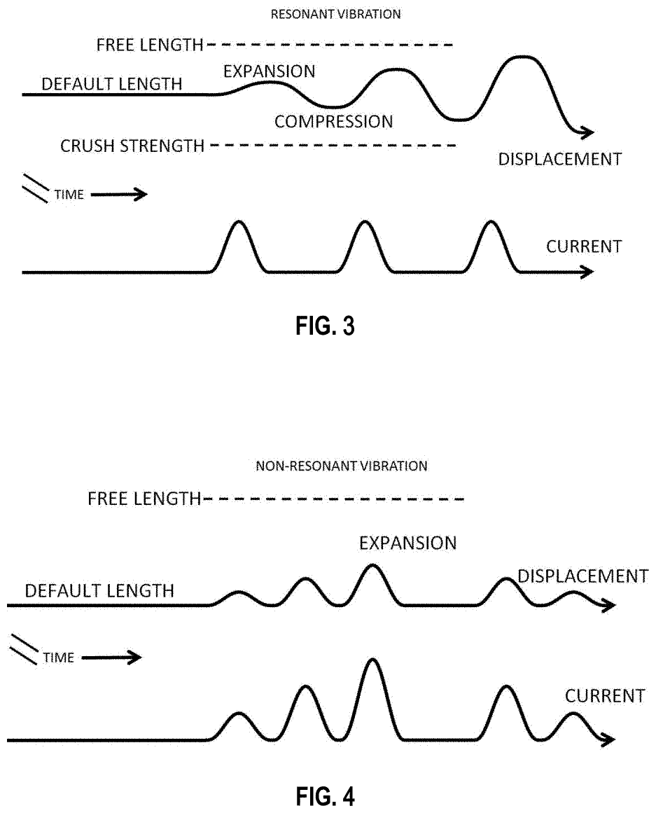

FIG. 3 illustrates a particular mode of operation enabled by this disclosure. Two normalized traces are shown with respect to time. The lower trace is electrical current, the cause of actuator expansion. From zero current, three separate input pulses of identical magnitude are shown. The three pulses are separated in time by identical amounts. More pulses can be added as desired.

The first current pulse, shown starting and stopping at zero with zero slopes, results in an initial actuator expansion from its default, preloaded, and unenergized position. The current has returned to zero at the moment that expansion has reached its maximum. With zero current and with biasing element 120 having been deflected, the balance of forces causes the load to compress magnetostrictive element 110 further than its default position.

By superposition, the two additional current pulses of the same magnitude increase the magnitude of the vibrational output of the actuator. The limits of vibration amplitude described above are included.

FIG. 4 illustrates a second particular mode of operation enabled by this disclosure. Two normalized traces are shown with respect to time. The lower trace is electrical current, the cause of actuator expansion. Each current pulse can be independent with respect to pulse width and magnitude and with respect to the amount of delay between it and the next pulse. Delay can be arbitrary down to zero. Each current pulse starts and stops at zero with zero slopes. This results in an actuator expansion starting and stopping at the default length with zero slopes.

In the mode shown in FIG. 4, the nature of the terbium alloy is readily apparent. That is, the expansion of magnetostrictive element 110 is a nearly linear scale of current. Further, the time rate of the expansion of magnetostrictive element 110 is a nearly linear scale of the time rate of change of current. Thus, shaping the current to start and stop at zero with zero slopes yields an expansion that starts and stops at the default length with zero slopes. Any number of such pulses of any magnitude and any delay down to zero delay between pulses can be strung together as desired.

The disclosure is not to be limited to the particular embodiments described herein. In particular, the disclosure contemplates numerous variations in which an appropriate sensor and feedback loop can translate an input force from a magnetostrictive actuator into an output response to provide precise control over vibration creation.

The terbium alloy offers high mechanical output and is therefore the preferred embodiment of this disclosure. However, it is not the only magnetostrictive material nor do magnetostrictive materials only expand under the influence of a magnetic field. For example, the word magnetostriction was coined to describe the constriction of iron under the influence of a magnetic field. Magnetostriction is exhibited by, for example, various combinations of other rare earth elements, iron, nickel, cobalt, aluminum, and gallium.

Similarly, piezoelectric materials that can operate for sufficient time near their destructive limit or limits are compatible with the present invention.

From the foregoing, it can be seen that the present invention accomplishes at least all of the stated objectives.

### EXAMPLES

Many applications will benefit from durable, precise, and continuously controllable high output magnetostrictive actuator technology. To illustrate the breadth of possibilities, the following examples are listed.

For a first example, some manufacturing processes require transfer of particles or powders or the like through equipment where they may stick to or otherwise clog the equipment. Vibration is a known remedy. Vibration of continuously variable force, displacement, and frequency will enhance certain of these processes.

For a second example, some higher-powered sources of vibration rotate an offset weight, limiting force and frequency while imposing maintenance requirements.

For a third example, a single pulse of expansion and contraction can be selected, the pulse having a magnitude and duration that are each separately and continuously selectable within the design range of a particular actuator embodiment. Not only can the pulse be single, but that mechanical output pulse can be shaped to start at zero expansion with zero slope and end at zero expansion with zero slope by appropriately shaping the electrical input pulse. That is, what has been colloquially termed “soft-start” can be implemented—the pulse can be shaped to avoid undesirable ringing and harmonics. Naturally, it follows that any number of pulses can be excited, here termed a “pulse train.” Given the actuator's continuous controllability, the pulse train can be formed from any number of individual pulses of any size within the same pulse train, the pulses being separated by any delay or delays down to zero delay.

A fourth example is identical to the third example above, except expansion can be selected to be different than contraction. Not only can expansion and contraction be different, they can be separated by any time delay and one or both can feature the soft start characteristic as desired.

For a fifth example, pulses superposed at resonance to generate high mechanical force and displacement from relatively smaller electrical input pulses can be used for industrial processes such as friction welding.

### LIST OF REFERENCE CHARACTERS

The following reference characters and descriptors are not exhaustive, nor limiting, and include reasonable equivalents. If possible, elements identified by a reference character may replace or supplement any element identified by another reference character.
100 actuator
110 magnetostrictive element
111 fixed end cap
112 moving end cap
120 preloading element
130 solenoid coil
131 bobbin
140 cylinder
141 first disk
142 second disk
150 output element
160 direction of expansion

The present disclosure is not to be limited to the particular embodiments described herein. The following claims set forth a number of the embodiments of the present disclosure with greater particularity.

1. An actuator comprising:
a magnetostrictive element:
operably connected to a solenoid coil;
preloaded to a default length;
having an expanded length greater than the default length;
having a compressed length less than the default length, wherein the compressed length of the magnetostrictive element is not less than a length at which permanent mechanical degradation of the magnetostrictive element occurs;
an output element disposed proximate to a terminal end of the actuator and movable between an original position and an actuated position;
wherein the solenoid coil is energized from a lower level to a higher level during expansion or contraction of the magnetostrictive element.

2. The actuator of claim 1 further comprising a biasing element operably connected to an output element and configured to bias the magnetostrictive element in its default length position.

3. The actuator of claim 1 wherein the magnetostrictive element comprises terbium, dysprosium, and iron.

4. The actuator of claim 1 wherein the magnetostrictive element is subject to a magnetic field from not less than one permanent magnet secured proximate to the magnetostrictive element.

5. The actuator of claim 1 wherein a length of the magnetostrictive element is selectively variable between the expanded length and compressed length to selectively displace the output element by the expansion or compression of the magnetostrictive element.

6. The actuator of claim 1 wherein the solenoid coil comprises one or more windings of conductive wire and further wherein the one or more windings of conductive wire are wound around a bobbin.

7. The actuator of claim 1 further comprising a magnetic flux return path comprising at least a fixed end cap at an end of the actuator opposite the terminal end.

8. The actuator of claim 1 wherein the magnetic flux return path further comprises a movable end cap at the terminal end.

9. The actuator of claim 1 wherein the magnetic flux return path further comprises a cylinder and a plurality of disks fabricated of ferromagnetic material.

10. A method for creating vibration comprising the steps of:
providing an actuator having a magnetostrictive element electromagnetically connected to a solenoid coil, a biasing element, and an output element;
energizing the solenoid coil from a lower magnitude to a higher magnitude to cause expansion of the magnetostrictive element or de-energizing the solenoid coil from a higher magnitude to a lower magnitude to cause compression of the magnetostrictive element; and
displacing the output element by the expansion or the compression of the magnetostrictive element.

11. The method of claim 10 wherein the solenoid coil is energized and de-energized in periods that at least nearly coincide with the harmonic mechanical resonant frequency of the combined actuator and load.

12. The method of claim 11 wherein energizing the solenoid coil causes the output element to be displaced in a direction away from a terminal end of the actuator.

13. The method of claim 10 wherein the applied electrical input begins with zero slope.

14. The method of claim 13 wherein the applied electrical input begins near zero.

15. The method of claim 10 wherein the applied electrical input ends with zero slope.

16. The method of claim 15 wherein the applied electrical input ends near zero.

17. The method of claim 10 further comprising winding the solenoid coil around a bobbin.

18. The method of claim 10 further comprising returning magnetic flux along a path defined in part by a movable end cap, a fixed end cap, a cylinder, and a plurality of disks.

19. A system comprising:
a control signal;
a source of energy for the control signal;
the actuator of claim 1; and
a mechanism configured to be mechanically moved when the actuator receives the control signal.

20. An actuator comprising:
a piezoelectric element:
preloaded to a default length;
having an expanded length greater than the default length;
having a compressed length less than the default length, wherein the compressed length of the piezoelectric element is not less than a length at which permanent mechanical degradation of the piezoelectric element occurs;
an output element disposed proximate to a terminal end of the actuator and movable between an original position and an actuated position;
wherein the piezoelectric element is energized from a lower level to a higher level during expansion or contraction of the piezoelectric element.
